(19) United States
(12) Patent Application Publication
(10) Pub. No.: US 2011/0166049 A1
(43) Pub. Date: Jul. 7, 2011

(54) UV Light Treatment Methods and System

(76) Inventors: Johanna A. Haggstrom, Duncan, OK (US); Jimmie D. Weaver, Duncan, OK (US); Lindsey M. Gloe, Duncan, OK (US); Jeremy Holtsclaw, Lawton, OK (US)

(21) Appl. No.: 12/830,984

(22) Filed: Jul. 6, 2010

Related U.S. Application Data
(63) Continuation-in-part of application No. 12/683,337, filed on Jan. 6, 2010.
Application No. 12/683,337 is a continuation-in-part of application No. 12/683,343, filed on Jan. 6, 2010.

(51) Int. Cl. C09K 8/62

(52) U.S. Cl. 507/201

(57) ABSTRACT

A method may include providing a wellbore treatment fluid having a first microorganism count as a result of the presence of at least a plurality of microorganisms in the wellbore treatment fluid, providing a UV light treatment reservoir, providing a UV light source, placing the wellbore treatment fluid in the UV light treatment reservoir, and irradiating the wellbore treatment fluid with the UV light source so as to reduce the first microorganism count of the wellbore treatment fluid to a second microorganism count to form an irradiated wellbore treatment fluid.

### CROSS REFERENCE TO RELATED APPLICATIONS

The present invention is a continuation-in-part of co-pending U.S. application Ser. No. 12/683,337, entitled “Mobile UV Light Treatment System and Associated Methods,” filed Jan. 6, 2010, and U.S. application Ser. No. 12/683,343, entitled “UV Light Treatment Methods and System,” filed Jan. 6, 2010, the entire disclosures of which are hereby incorporated by reference.

### BACKGROUND

The present invention relates to methods of killing microorganisms found in wellbore treatment fluids, and more specifically, to the use of ultraviolet (UV) light to reduce microorganism counts in such wellbore treatment fluids.

The presence of microorganisms, including bacteria, algae, and the like, in wellbore treatment fluids can lead to contamination of a producing formation, which is undesirable. The term microorganism as used herein refers to living microorganisms unless otherwise stated. For example, the presence of anaerobic bacteria (e.g., sulfate reducing bacteria (“SRB”)) in an oil and/or gas producing formation can cause a variety of problems including the production of sludge or slime, which can reduce the porosity of the formation. In addition, SRB produce hydrogen sulfide, which, even in small quantities, can be problematic. For instance, the presence of hydrogen sulfide in produced oil and gas can cause excessive corrosion to metal tubular goods and surface equipment, and the necessity to remove hydrogen sulfide from gas prior to sale. Additionally, the presence of microorganisms in a viscosified treatment fluid can alter the physical properties of the treatment fluids by degrading the viscosifying polymer, leading to a decrease in viscosity, a possible significant reduction in treatment fluid productivity, and negative economic return.

Microorganisms may be present in wellbore treatment fluids as a result of contaminations that are present initially in the base treatment fluid that is used in the treatment fluid or as a result of the recycling/reuse of a wellbore treatment fluid to be used as a base treatment fluid for a treatment fluid or as a treatment fluid itself. In either event, the water can be contaminated with a plethora of microorganisms.

Biocides are commonly used to counteract biological contamination. The term “biological contamination,” as used herein, may refer to any living microorganism and/or by-product of a living microorganism found in treatment fluids used in well treatments. For wellbore use, commonly used biocides are any of the various commercially available biocides that kill microorganisms upon contact, and which are compatible with the treatment fluids used and the components of the formation. In order for a biocide to be compatible and effective, it should be stable, and preferably, it should not react with or adversely affect components of the treatment fluid or formation. Incompatibility of a biocide in a wellbore treatment fluid can be a problem, leading to treatment fluid instability and potential failure. Biocides may comprise quaternary ammonium compounds, chlorine, hypochlorite solutions, and compounds like sodium dichloro-s-triazinetrione. Crosslinking biocides may be used in the present invention. An example of a crosslinked biocide that may be used in subterranean applications is glutaraldehyde.

Because biocides are intended to kill living organisms, many biocidal products pose significant risks to human health and welfare. In some cases, this risk is due to the high reactivity of the biocides. As a result, their use is heavily regulated. Moreover, great care is advised when handling biocides and appropriate protective clothing and equipment should be used. Storage of the biocides also may be an important consideration.

High intensity UV light has been used to kill bacteria in aqueous liquids. There are four UV-light classifications: UV-A, UV-B, UV-C, and UV-V. The UV-C class is considered the germicidal wavelength, with the germicidal activity being at its peak at a wavelength of 254 nm. The rate at which UV light kills microorganisms in a treatment fluid is a function of various factors including, but not limited to, the time of exposure, and the UV transmittance, and the flux (i.e., intensity) to which the microorganisms are subjected. For example, in a flow through cell type embodiment, a problem that may be associated with conventional UV light treatment systems is that inadequate penetration of the UV light into an opaque treatment fluid may result in an inadequate kill. Additionally, in such situations, to achieve optimal results, maintaining the exposure to UV light at a sufficient flux for as long a period of time as possible is desirable, to maximize the degree of penetration so that the biocidal effect produced by the UV light treatment may be increased. Another challenge is the turbidity of the treatment fluid. “Turbidity,” as that term is used herein, is the cloudiness or haziness of a treatment fluid caused by individual particles (e.g., suspended solids) and other contributing factors that may be generally invisible to the naked eye. The measurement of turbidity is a key test of water quality. The partial killing of the bacteria can result in the re-occurrence of the contamination, which is highly undesirable in the subterranean formation.

### SUMMARY

The present invention relates to methods of killing microorganisms found in wellbore treatment fluids, and more specifically, to the use of ultraviolet (UV) light to reduce microorganism counts in such wellbore treatment fluids.

In some embodiments, a method comprises providing a wellbore treatment fluid having a first microorganism count as a result of the presence of at least a plurality of microorganisms in the wellbore treatment fluid; providing a UV light treatment reservoir; providing a UV light source; placing the wellbore treatment fluid in the UV light treatment reservoir; and irradiating the wellbore treatment fluid with the UV light source so as to reduce the first microorganism count of the wellbore treatment fluid to a second microorganism count to form an irradiated wellbore treatment fluid.

The features and advantages of the present invention will be readily apparent to those skilled in the art. While numerous changes may be made by those skilled in the art, such changes are within the spirit of the invention.

### BRIEF DESCRIPTION OF DRAWINGS

This drawing illustrates certain aspects of some of the embodiments of the present invention, and should not be used to limit or define the invention.

FIG. 1 illustrates a schematic of a UV light treatment reservoir in accordance with one embodiment of the present invention.

While the present invention is susceptible to various modifications and alternative forms, a specific exemplary embodiment thereof has been shown by way of example in the drawing and is herein described in detail. However, the description herein of specific embodiments is not intended to limit the invention to the particular form disclosed, but on the contrary, the intention is to cover all modifications, equivalents and alternatives falling within the spirit and scope of the invention as defined by the appended claims.

### DETAILED DESCRIPTION

The present invention relates to methods of killing microorganisms found in wellbore treatment fluids, and more specifically, to the use of ultraviolet (UV) light to reduce microorganism counts in such wellbore treatment fluids.

The methods of the various embodiments of the present invention may combat biological contamination in well fluids, while reducing or eliminating reliance on biocides that can bring their own set of complications.

In some embodiments, the systems and methods disclosed herein may be used in any type of hydrocarbon industry application, operation, or process where disinfecting a turbid treatment fluid is desired, including, but not limited to, pipeline operations, well servicing operations, upstream exploration and production applications, and downstream refining, processing, storage and transportation applications. The term “turbid treatment fluid” as used herein refers to a fluid having 1% to 90% transmittance at 254 nm, and in some instances, 50% to 90% transmittance at 254 nm. While the term “turbid treatment fluid” is used in many instances herein, similar processes and techniques may apply equally to non-turbid treatment fluids.

While not wanting to be limited by any particular theory, the cellular DNA of microorganisms absorbs the energy from the UV light, causing adjacent thymine molecules to dimerize or covalently bond together. The dimerized thymine molecules are unable to encode RNA molecules during the process of protein synthesis. The replication of the chromosome before binary fission is impaired, leaving the bacteria unable to produce proteins or reproduce, which ultimately leads to the death of the organisms. This system oftentimes is most effective when treating waters with a low turbidity. Waters with high turbidity affect how the UV light photons transmit through the water. Treated water having at least 85% T (transmittance) measured at 254 nm is recommended, in order to effectively kill the bacteria and pump at a high flow rate, e.g., 100 bpm.

The systems and methods disclosed herein may be useful for both aqueous-based, oil-based turbid treatment fluids, and combinations thereof. Suitable turbid treatment fluids for the present invention may comprise virgin fluids (e.g., those that have not been used previously in a subterranean operation) and/or recycled fluids. Virgin fluids may contain water directly derived from a pond or other natural source. Recycled fluids may include produced and/or flowback (e.g., those that have been used in a previous subterranean operation) waters or other fluids. In certain embodiments, the virgin fluids may be contaminated with a plethora of microorganisms, having an initial microorganism count in the range of about 10² bacteria/mL to about 10¹⁵ bacteria/mL. In some embodiments, 10¹⁵ bacteria/mL or greater may be common. Recycled fluids may be similarly contaminated as a result of having been previously used in a subterranean formation or stored on-site in a contaminated tank or pit. Recycled fluids may have a first microorganism count in the same range, but may have a different bacterial contamination, sometimes comprising a mix of different bacteria that are harder to kill than those that are usually present in virgin fluids.

In addition to reducing the amount of contamination in oil field operations, the methods disclosed herein may allow for a reduction in the amount of chemical biocides used, leading to improved economic return and production of a more environmentally safe treatment fluid, at least under current (as of the time of filing) environmental standards and regulations. Elimination or reduction of such harmful biocides may additionally reduce injuries on location due to chemical exposure of such chemicals. Further, some embodiments of the present invention describe a portable UV light treatment reservoir, thereby diminishing the cost of transferring treated water to a remote location such as a well site. Further, the present invention provides a system capable of treating large quantities of a turbid treatment fluid on-site, improving the ability to reclaim and re-use the scarce water found in such remote locations.

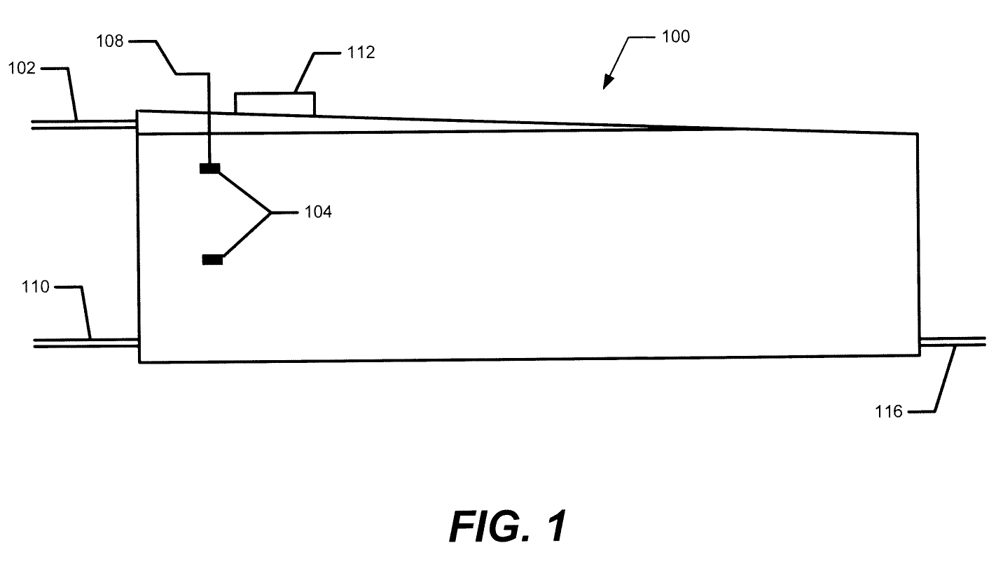

Referring to FIG. 1, UV light treatment reservoir 100 may be used to disinfect water or other turbid treatment fluids, including those used in fracturing and other oilfield applications. UV light treatment reservoir 100 may include one or more inlets 102; UV light source 104; power source 108; aerator 110; one or more access hatches 112; one or more agitators 114; and one or more outlets 116.

UV light treatment reservoir 100 may be a modified frac tank, as illustrated in FIG. 1, a pit, or any other open or closed cavity, container, vessel, tank, pit, or cavity for holding treatment fluids. In some embodiments, UV light treatment reservoir 100 may be from about 1,000 gallons to about 50,000 gallons. A frac tank may be a mobile steel storage tank configured to hold approximately 21,000 gallons of liquid, or any other container known as a frac tank to those having ordinary skill in the art. A pit may be larger, e.g., more than 20,000 barrels in volume.

Inlet 102 may be a port or other opening allowing fluid to enter UV light treatment reservoir 100. In some embodiments, the fluid passing through inlet 102 may be turbid treatment fluid from a turbid treatment fluid supply source. In other embodiments, the fluid passing through inlet 102 may be disinfected or partially disinfected fluid.

UV light source 104 may be contained entirely within UV light treatment reservoir 100, with any number of bulbs either suspended within or attached to an interior of UV light treatment reservoir 100, as illustrated in FIG. 1. Alternatively, UV light source 104 may be partially contained within UV light treatment reservoir 100, either at or near inlet 102, outlet 116, or otherwise fluidly connected to UV light treatment reservoir 100. In some embodiments, UV light source 104 may be present between UV light treatment reservoir 100 and other components or systems connected thereto. In some embodiments, UV light source 104 may include sunlight, either as the only UV light source 104, or as a part of UV light source 104. For example, when UV light treatment reservoir 100 is a pit, sunlight may be the only UV light source 104 necessary.

Power source 108 may provide energy for UV light source 104 and may be external to UV light treatment reservoir 100 as illustrated in FIG. 1, internal to UV light treatment reservoir 100, or both. In some embodiments, power source 108 is connected to UV light source 104 via conduit formed within UV light treatment reservoir 100.

Aerator 110 may be an air injection port, an air injection line, a fountain, a pump, or any of a number of other devices configured to introduce air into UV light treatment reservoir 100, in order to mix the attenuating agent with the water source to ensure maximum biocidal kill.

When UV light treatment reservoir 100 is a closed cavity, access hatch 112 may allow observation and/or sampling, and/or servicing of UV light treatment reservoir 100.

Agitator 114 may provide increased fluid movement and aid in greater exposure of the treatment fluid to UV light source 104. Agitator 114 may be a static fluid mixer, a turbulator, a small recirculation pump, a weir system, or any other energy source useful in circulating or re-circulating the treatment fluid, either continuously or intermittently. Agitator 114 is illustrated within UV light treatment reservoir 100 in FIG. 1. However, agitator 114 may be partially or wholly outside of UV light treatment reservoir 100, depending on the particular conditions present.

Outlet 116 may be a port, pipe, or other opening allowing fluid to exit UV light treatment reservoir 100. In some embodiments, the fluid may pass through outlet 116 before moving into a subterranean formation, a pipeline, a downstream refining process, a mixing system, or a storage container for later re-use.

UV light treatment reservoir 100 may be transported to a jobsite, in the case of a frac tank, or UV light treatment reservoir 100 may be formed at the jobsite, in the case of a pit. In either event, a treatment fluid having a first microorganism count, because of the presence of a plurality of microorganisms, may be introduced into UV light treatment reservoir 100 via inlet 102. Alternatively, the treatment fluid may be introduced into UV light treatment reservoir 100 naturally (e.g., via rainfall). UV light source 104 may be provided inside UV light treatment reservoir 100, or externally, depending on the configuration of UV light treatment reservoir 100. For example, if UV light treatment reservoir 100 is a pit, UV light treatment source 104 may be provided passively, in the form of sunlight, and an attenuating agent and agitator 114 and/or an aeration source may be more desirable. The term “attenuating agent” as used herein refers to UV sensitive photoinitiator compounds that are labile, and that on exposure to UV light, decompose to form free radicals that can kill microorganisms. UV light treatment reservoir 100 may comprise a variety of different types of filters, depending upon the requirement of the operation, including sock filters, boron removal filters, micron particle filters, activated charcoal filters, and any other type of filter to make the treatment fluid suitable for the intended operation.

Once treatment fluid is present in UV light treatment reservoir 100, UV light source 104 may irradiate the treatment fluid present in UV light treatment reservoir 100, reducing the microorganism count from a first microorganism count to a second microorganism count while forming an irradiated treatment fluid. In some embodiments, the treatment fluid may be agitated and/or aerated, either before or during irradiation. In some instances, agitation may occur while UV light treatment reservoir 100 is on standby, which may allow for smaller UV light source 104. In some embodiments, an attenuating agent may be added to the treatment fluid, such that a plurality of free radicals is generated. These free radicals may interact further with the microorganisms in the fluid, reducing the microorganism count further.

Optionally, the turbid treatment fluid may be pretreated (e.g., to remove solids, debris, and the like) prior to being placed in the UV light treatment reservoir 100 (e.g., before inlet 102), thus increasing the UV light transmittance. In another embodiment, removing at least a portion of the biological material in the fluid before it is exposed to UV light source 104 may be desirable. Such prior treatment enhances the efficiency of the UV light treatment. In any event, inlet 102 allows the turbid treatment fluid supply source into UV light treatment reservoir 100 to be irradiated. The term “irradiated” or “irradiating,” as used herein, generally refers to the process by which the treatment fluid is exposed to UV radiation for the purposes of disinfecting a turbid treatment fluid.

The turbid treatment fluid supply source may comprise a number of fluids including virgin fluids, recycled fluids, natural fluids (e.g., from ponds), oil-based fluids, and the like. An optional pre-treatment stage, in some embodiments, may involve the addition of an optional biocide if the contamination in the fluid is such that this would be useful. Preferably, this pre-treatment occurs before the irradiation process in UV light treatment reservoir 100, thereby enhancing the UV treatment process.

Optionally, a biocide may be placed in the turbid treatment fluid through a chemical biocide injection pump, when the turbidity of the fluid is too high for effective UV light disinfection. In such embodiments, optional biocides may be added at inlet 102, outlet 116, or elsewhere, to control contamination. The chemically treated treatment fluid may then move through outlet 116 to the wellhead and downhole to perform the desired operation. In certain embodiments, the turbid treatment fluid may be treated by both UV light treatment reservoir 100 and chemical biocides. This method may allow for a more powerful disinfection and effective treatment of more serious contaminations. In some embodiments, free radical generators may be added to the treatment fluids prior to placing the fluids in contact with UV light source 104, to increase the biocidal effect and reduce contamination.

Optionally, inlet 102 may comprise a device that imparts turbulence to the fluid to disperse microorganisms within the turbid treatment fluid and prevent the formation of a biofilm in the fluid. Increasing turbulence may allow more of the turbid fluid to be exposed to UV light source 104. Both the power of UV light source 104 and the duration to which the fluids are exposed to UV light source may be decreased in the present invention.

After irradiation, the irradiated treatment fluid may optionally be passed to a mixing system, where it may be combined with additives such as gelling agents, proppant particulates, gravel particulates, friction reducing agents, corrosion inhibitors, as well as other chemical additives to form a blended slurry. The mixing system may comprise a blender for fracturing fluids. The mixing system may comprise a pump, such as a suction pump, that can be used to facilitate the movement of the turbid treatment fluid through UV light treatment reservoir 100. In some embodiments, such chemical additives may be blended with the treatment fluid before it is moved to a pump. The treatment fluid may then move to a wellhead and downhole to perform a desired subterranean operation.

In another embodiment, the turbid treatment fluid may be passed through UV light treatment reservoir 100 directly to one or more pumps. Pumps suitable for use in the present invention may be of any type suitable for moving treatment fluid and compatible with the treatment fluids used. In some embodiments, the pump may be a high-pressure pump, which may pressurize the treatment fluid. In some embodiments, the pumps may be staged centrifugal pumps, or positive displacement pumps, but other types of pumps may also be appropriate. The treatment fluid may then move to a wellhead and downhole to perform a desired subterranean operation.

In some embodiments, where a mixing system is used after a pump, by providing for the addition of proppant particulates, gels and any other suitable chemical additives after the treatment fluid has passed through the pumps, life expectancy and reliability of the pumps may improve, and maintenance costs may diminish over traditional methods involving erosive and abrasive forces caused by proppant-laden treatment fluids passing through dirty pumps. Additionally, this method may allow for independent optimization of operations. In other words, in some embodiments, an operator may separately optimize the high-pressure pumping operations and abrasive additive operations.

The methods of the present invention are able to combat biological contamination in well fluids, while reducing or eliminating reliance on biocides that can bring their own set of complications. The UV light fluid treatment systems of the present invention may have a much greater biocidal effect than conventional systems, and may achieve deeper penetration into the fluid and a more complete kill, or even a total kill, of the biological contamination found therein. This may permit fluids to be reclaimed and re-used in oilfield operations. In addition, the systems may present little or no chemical concerns under environmental laws and regulations. These systems may allow for the diminished need for a high flux UV light source or increased exposure in some embodiments, especially as compared to typical UV light fluid treatment systems, because the systems of the present invention may achieve deeper penetration into fluids.

One of the benefits of the present invention is that timing of treatment may be carefully chosen to best fit a desired application. To initiate treatment, the optional attenuating agents should be exposed to the UV light source to facilitate the release of free radicals. Another benefit may be that the free radical initiators may not be biocidal until they are activated by UV light source 116 and so they may be kept in the fluids until contamination is present and then activated to control bacterial growth. This delayed generation of biocides through the reaction of UV light and free radical forming material allows for controlled placement of the fluid and alleviates handling and exposure concerns often associated with the use of conventional chemical biocides.

In some embodiments, attenuating agents may be used in combination with UV light treatment reservoir 100 to decrease the necessity of long and repeated exposures to high power UV lights. The attenuating agents are thought to effectively prolong the effect of the UV light and its reaction with the microorganisms. As well understood by a person having ordinary skill in the art, when attenuating agents are exposed to a UV light source, even at low levels, they photoisomerize to release free radicals. The free radicals may then act to decompose microorganisms (e.g., bacterial membranes) within the treatment fluid. In addition, longer biocidal action should be realized at least in most embodiments by selecting the appropriate free-radical-forming material based on solubility, reactivity, and free radical half-life. Additionally, the UV light treatment fluid treatment systems of the present invention desirably effectively generate free radicals with long half-lives so that even after the treatment, biocidal action may be stimulated in the treatment fluids used in well treatments, thus continuing to kill bacteria, and remove contamination to recover production in formations.

In one embodiment, the present invention comprises a method comprising: providing a treatment fluid having a first microorganism count as a result of the presence of at least a plurality of microorganisms in the fluid; providing a UV light treatment reservoir; providing a UV light source; placing the treatment fluid in the UV light treatment reservoir; and irradiating the treatment fluid with the UV light source so as to reduce the first microorganism count of the treatment fluid to a second microorganism count to form an irradiated treatment fluid.

The attenuating agents of the present invention can be introduced into any suitable treatment fluid that is applicable to the chosen operation. The compositions and methods of the present invention may be useful for any subterranean treatment fluid. Examples of suitable treatment fluids include any known subterranean treatment fluid, including those in high volume, (e.g., drilling and fracturing fluids), and those that are lower in volume (e.g., pills). Nonlimiting examples of the types of suitable treatment fluids include, but are not limited to, aqueous-based fluids, brines, foams, gases and combinations thereof (such as emulsions). In certain embodiments, the treatment fluids may be contaminated with a plethora of microorganisms, having an initial microorganism count in the range of about 10² to about to 10¹⁵ bacteria/mL. In some embodiments, 10¹⁰ bacteria/mL or greater may be common. As will be recognized by a person having ordinary skill in the art, recycled fluids may comprise a mix of bacteria that are harder to kill than those that are usually present in virgin fluids.

Suitable attenuating agents for use in the treatment fluids and methods of the present invention include organic and inorganic attenuating agents. The solubility and/or dispersability of an attenuating agent may be a consideration when deciding whether to use a particular type of attenuating agent. Some of the attenuating agents may be modified to have the desired degree of solubility or dispersability. Cost and environmental considerations might also play a role in deciding which to use. In addition, the method of use in the methods of the present invention may be a factor as well. For example, some methods may call for a less soluble agent whereas others may be more dependent on the solubility of the agent in the treatment fluid. The particular attenuating agent used in any particular embodiment depends on the particular free radical desired and the properties associated with that free radical. Some factors that may be considered in deciding which of the attenuating agents to use include, but are not limited to, the stability, persistence, and reactivity of the generated free radical. The desired stability also depends on the amount of contamination present and the compatibility the free radicals have with the treatment fluid composition. To choose the right attenuating agent for treatment, one should balance stability, reactivity, and incompatibility concerns. Those of ordinary skill in the art with the benefit of this disclosure will be able to choose an appropriate attenuating agent based on these concerns.

Suitable organic attenuating agents for use in the present invention, include, but are not limited to, one or more water-soluble photoinitiators that undergo cleavage of a unimolecular bond in response to UV light and release free radicals. Under suitable conditions and appropriate exposure to UV light, the attenuating agents of the present invention will yield free radicals, such as in the example of Scheme 1 below:

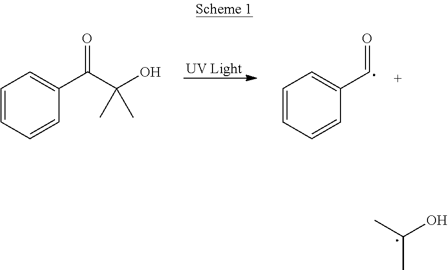

Suitable attenuating agents may be activated by the entire spectrum of UV light, and may be more active in the wavelength range of about 250-500 nm. The molecular structure of the attenuating agent will dictate which wavelength range will be most suitable. Some attenuating agents undergo cleavage of a single bond and release free radicals. Each organic attenuating agent has a life span that is unique to that attenuating agent. Generally, the less stable the free radical formed from the attenuating agent the shorter half-life and life span it will have.

Suitable organic attenuating agents for use in the present invention may include, but are not limited to, acetophenone, propiophenone, benzophenone, xanthone, thioxanthone, fluorenone, benzaldehyde, anthraquinone, carbazole, thioindigoid dyes, phosphine oxides, ketones, and any combination and derivative thereof. Some attenuating agents include, but are not limited to, benzoinethers, benzilketals, alpha-dialkoxyacetophenones, alpha-hydroxyalkylphenones, alpha-aminoalkylphenones, acylphosphineoxides, and any combination or derivative thereof. Other attenuating agents undergo a molecular reaction with a secondary molecule or co-initiator, which generates free radicals. Some additional attenuating agents include, but are not limited to, benzophenones, benzoamines, thioxanthones, thioamines, and any combination or derivative thereof. These materials may be derivatized to improve their solubility with a suitable derivatizing agent. Ethylene oxide, for example, may be used to modify these attenuating agents to increase their solubility in a chosen treatment fluid. Such attenuating agents may absorb the UV light and undergo a reaction to produce a reactive species of free radicals (See Scheme 1, for instance) that may in turn trigger or catalyze desired chemical reactions.

In certain embodiments, free radicals released through the activation of attenuating agents initiate damage to living microorganisms. In certain embodiments, the mode of action for the attenuating agents may be the interaction of the released free radicals with the microorganisms so as to disrupt the cellular structures and processes of the microorganism. In some instances, the biocidal effect due to prolonged life associated with each free radical is thought to increase with increasing free radical stability and reactivity. For certain aspects of the present invention, consideration of the life span or half-life of the free radicals that will result may be important. Some free radicals may be very active even though they have short life spans. Some free radicals may be more active in the presence of the UV light whereas some may retain the activity even outside direct exposure to the UV light. The term “half-life” as used herein refers to the time for half of the original amount of the free radicals generated to decay. The term “life span” refers to the total time for the free radical to decay almost completely. For instance, a free radical with a longer half-life will result in a longer lasting biocidal effect, limiting the need for UV light exposure and therefore, may be more useful in treatment fluids having a high turbidity.

Alternatively, inorganic attenuating agents may be used in certain embodiments. When exposed to UV light, these agents will generate free radicals that will interact with the microorganisms as well as other organics in a given treatment fluid. In preferred embodiments, these may include nanosized metal oxides (e.g., those that have at least one dimension that is 1 nm to 1000 nm in size). In some instances, these inorganic nanosized metal oxide attenuating agents may agglomerate to form particles that are micro-sized. Considerations that should be taken into account when deciding the size that should be chosen include a balance of surface reactivity and cost. Examples of suitable inorganic attenuating agents include, but are not limited to, nanosized titanium dioxide, nanosized iron oxides, nanosized cobalt oxides, nanosized chromium oxides, nanosized magnesium oxides, nanosized aluminum oxides, nanosized copper oxides, nanosized zinc oxides, nanosized manganese oxides, and any combination or derivative thereof. Titanium dioxide, for example produces hydroxyl radicals upon exposure to UV light. These hydroxyl radicals, in one mechanism, are very useful in combating organic contaminants. These reactions can generate CO₂. Nanosized particles are used because they have an extremely small size maximizing their total surface area and resulting in the highest possible biocidal effect per unit size. As a result, nanosized particles of metal oxides provide a higher enhancement of kill rate efficiency than larger particles used in much higher concentrations. An advantage of using such nanosized metal oxide particles in combating contamination is that the treated microorganisms cannot acquire resistance to such metal particles, as commonly seen with other biocides.

In some embodiments, a thin film of pure titanium dioxide or other inorganic attenuating agent may be used in conjunction with UV light treatment reservoir 100. In such instances, the inorganic attenuating agent may be crystalline. Techniques that may be used to form such films include, but are not limited to, chemical vapor deposition techniques, pulsed laser deposition techniques, reactive sputtering and sol-gel deposition processes, and/or dip-coating processes. In other embodiments, the pure titanium dioxide may be incorporated within a polymeric film in an amount up to a certain desired weight %. The polymeric film may comprise polyurethane. Techniques that may be used to form such films may include any suitable technique including, but not limited to, sol-gel techniques. The weight % could be anywhere from a very low number (close to zero) up to 80% or more, depending on what is deemed to be useful without causing undue expense. Depending on where the film is located, the film may or may not be transparent. Both types of films discussed above may be transparent, in some instances. For instance, if the film is placed on the quartz sleeve which encases the UV bulb, having the film be transparent would be desirable, so that the UV light is able to pass through the film and interact with the fluid.

In yet other embodiments, the inorganic attenuating agents can be added as solid particles to a treatment fluid. In other embodiments, the inorganic attenuating agents may be used in a suspension form, e.g., in water. This might be useful when coating an element of a UV system in which the UV light will be used. In an alternative embodiment, a thin film of the nanosized metal oxide may be placed on UV light treatment reservoir 100 (e.g., on the interior of a frac tank or pit, on the quartz sleeve surrounding the UV light bulbs, as a coating of other components such as vanes associated with agitator 114, etc.) that is being used in a given system. The thin film may be made from a suitable polymer wherein the inorganic attenuating agent has been deposited. In other embodiments, the inorganic attenuating agent may be deposited on an interior wall (or other interior portion) of UV light treatment reservoir 100 through a vapor deposition technique. An advantage of using inorganic attenuating agents or a thin film in such a manner is that the system becomes self-cleaning.

The concentration of the nanosized metal oxide in the film used in the present invention may range up to about 0.05% to 10% by weight of the film by dry weight. The particular concentration used in any particular embodiment depends on what free radical compound is being used, and what percentage of the treatment fluid is contaminated. Other complex, interrelated factors that may be considered in deciding how much of the nanosized metal oxides to include, but are not limited to, the composition contaminants present in the treatment fluid (e.g., scale, skin, calcium carbonate, silicates, and the like), the particular free radical generated, the expected contact time of the formed free radicals with the bacteria, etc. The desired contact time also depends on the amount of contamination present and the compatibility the free radicals have with the treatment fluid composition. For instance, to avoid incompatibility, treating the water source prior to mixing in with the other components of the treatable treatment fluids may be desirable. A person of ordinary skill in the art, with the benefit of this disclosure, will be able to identify the type of nanosized metal oxides as well as the appropriate concentration to be used.

The concentration of the attenuating agent used in the treatment fluids of the present invention may range up to about 5% by weight of the turbid treatment fluid. The particular concentration used in any particular embodiment depends on what free radical compound is being used, and magnitude of contamination present in the turbid treatment fluid. Other complex, interrelated factors that may be considered in deciding how much of the attenuating agent to include, but are not limited to, the composition contaminants present in the turbid treatment fluid (e.g., scale, skin, calcium carbonate, silicates, and the like), the particular free radical generated, the expected contact time of the formed free radicals with the bacteria, etc. The desired contact time also depends on the amount of contamination present and the compatibility the free radicals have with the turbid treatment fluid composition. For instance, to avoid incompatibility, treating the water source prior to mixing in with the other components of the turbid treatment fluid may be desirable. A person of ordinary skill in the art, with the benefit of this disclosure, will be able to identify the type of attenuating agents as well as the appropriate concentration to be used.

Many attenuating agents are liquids, and can be made to be water-soluble or water insoluble. Similarly, attenuating agents may exist in solid form, and can be made to be water-soluble or water-insoluble.

In some embodiments, the flow rate may be adjusted according to the turbidity of the treatment fluid in order to obtain an acceptable reduction of the bacteria and microorganisms found in the treatment fluids. In one embodiment, a UV light fluid treatment system may be used as an initial shock treatment to get an immediate reduction in the number of microorganisms present in the turbid treatment fluid. Once the initial shock treatment is completed, then small quantities of chemical biocides may be added to complete the disinfection. In certain embodiments, subsequent shock treatments may also be used to further reduce the amount of biocide necessary. In other embodiments, the initial UV light fluid treatment system may be used as an initial shock treatment to disinfect the equipment prior to use in wellbore operations in accordance with the present invention. As used herein, the term “disinfect” shall mean to reduce the number of bacteria and other microorganisms found in a turbid treatment fluid.

In certain embodiments of the present invention, chemicals may be added to the turbid treatment fluid before it is irradiated to decrease turbidity and increase the effectiveness of the UV light treatment. Such chemicals may include attenuating agents. The particular amount of UV exposure used in any particular embodiment depends on the turbidity of the contaminated treatment fluid and the magnitude of contamination present in the turbid treatment fluid. The irradiated treatment fluid may then be directed to an outlet for disposal to the environment or re-use in another operation. Suitable outlets may be any type of outlet, including valves used to direct treatment fluid flow and which are compatible with treatment fluids used in the specific operation. Alternatively, instead of re-using the irradiated treatment fluid at the same well site, the treatment fluid may be hauled by truck or transported by other means for re-use at a remote well site. If diverted for disposal, testing may be done to ensure that the irradiated treatment fluid is safe before it is released to the environment, which may be a water source, e.g., river or lake; a land surface; or injected into a disposal well.

If the irradiated treatment fluid is diverted for re-use, additives such as gelling agents, proppant particulates, and other treatment fluid components may be added to produce the treatment fluid. The treatment fluid may then be introduced into the wellbore to conduct a fracturing operation or other desired subterranean operation.

In another embodiment, the free radical generators and UV light exposure by UV light source 104 both occur at or near UV light treatment reservoir 100. In yet another embodiment, the treatment fluid may be reclaimed and then treated to eliminate contamination prior to storage and re-use. This method allows the production of re-usable fluids, thereby conserving the sparse water supply.

High-pressure pumps in the present invention may be of any type suitable for moving fluid and compatible with the fluids used. High-pressure pumps may pressurize the fluid. In some embodiments, the pumps may be staged centrifugal pumps, or positive displacement pumps, but other types of pumps may also be appropriate. After passing through the pumps, the treatment fluid may join proppant particulates, gels, and other chemical additives. In some embodiments, the treatment fluid may comprise these additives prior to passing through the high-pressure pump. The treatment fluid may then move through the wellhead and downhole to a perforated zone to perform the desired subterranean operation.

The pump rates in embodiments of the present invention may be increased, by the addition of free radical generators in the treatment fluids. The rate increase depends both on the nature of the contamination and the effectiveness of the free radical formed. The present invention also provides the possibility of decreasing the power demand by reducing the amount of UV light necessary to eliminate the contamination. Due to the turbidity of the fluids, the amount of UV light that actually passes through and penetrates the fluid is low and usually results in an incomplete kill. The present invention provides a method where relatively very little UV light is necessary versus conventional systems to have a substantial biocidal effect by taking advantage of free radical forming compounds.

The treatment fluid comprising the attenuating agents may be exposed to the UV light source before being introduced to the subterranean formation. Suitable UV light sources for use with the present invention may include any radiation source suitable for use in subterranean applications, including, but not limited to, UV light, sunlight, artificial light, and the like. Mercury vapor, xenon, and tungsten lamps are examples of suitable radiation light sources. In some embodiments, the UV light source may comprise one or more germicidal UV light sources in a series or in parallel. The entire range of the UV light spectrum may be suitable.

In some embodiments, the system according to the present invention may use low to medium pressure germicidal UV lamps configured and functioning. Ultraviolet light is classified into four wavelength ranges: UV-V from about 100 nanometers (nm) to about 200 nm; UV-C, from about 200 nm to about 280 nm; UV-B, from about 280 nm to about 315 nm; and UV-A, from about 315 nm to about 400 nm. Generally, UV light, and in particular, UV-C light is germicidal. Germicidal, as used herein, generally refers to eliminating bacteria and other microorganisms. Specifically, while not intending to be limited to any theory, UV-C light is believed to cause damage to the nucleic acid of microorganisms by forming covalent bonds between certain adjacent bases in the DNA. The formation of these bonds is thought to prevent the DNA from being “unzipped” for replication, and the organism is unable to produce molecules essential for life process, nor is it able to reproduce. When an organism is unable to produce these essential molecules or is unable to replicate, it dies. UV light with a wavelength of approximately between about 250 nm to about 260 nm is believed to provide the highest germicidal effectiveness.

While the susceptibility of the microorganisms to UV light and the free radicals formed varies depending on volume and properties of the treatment fluid as well as the amount and properties of the attenuating agent added, a person of ordinary skill in the art with the benefit of this disclosure would be able to optimize the conditions necessary to adequately deactivate over 90 percent of microorganisms found in the treatment fluid. In certain embodiments of the present invention, a broad range of UV light wavelengths may be used, including but not limited to the range of about 250 nm to about 500 nm, with a preferred range of about 250 nm to 400 nm. In some embodiments, exposure to UV energy of about 60,000 watts may be adequate to deactivate over 90 percent of microorganisms. In some embodiments, each light bulb used in the present invention has a UV energy of about 1700 watts to about 3800 watts.

The treatment fluids of the present invention may comprise any additives that may be needed for the fluid to perform the desired function or task, providing that these additives do not negatively interact with the degradable diverting agents of the present invention. Such additives may include gelling agents, gel stabilizers, salts, pH-adjusting agents, corrosion inhibitors, dispersants, flocculants, acids, foaming agents, antifoaming agents, H₂S scavengers, lubricants, particulates (e.g., proppant or gravel), bridging agents, weighting agents, scale inhibitors, biocides, friction reducers, and the like. Suitable additives for a given application will be known to one of ordinary skill in the art. In certain embodiments, the addition of such additives to the treatment fluids of the present invention may be done at the job site in a method characterized as being performed “on the fly.” The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing.

In certain embodiments, optionally, when conditions indicate that effective UV light disinfection of the treatment fluids comprising the free radical generators is not enough; chemical biocides may be added to increase the disinfection power. Suitable chemical biocides for use in the present invention may include any chemical biocide that is suitable for use in a subterranean application. Minimal or no use of such chemical biocides is preferred.

In various embodiments, the present invention may be used either in combination with methods previously described, or as a single treatment system, depending on the microorganism count of the treatment fluid. When used downstream of the methods previously described, the methods described herein may further reduce the number of microorganisms.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. The particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing a wellbore treatment fluid having a first microorganism count as a result of the presence of at least a plurality of microorganisms in the wellbore treatment fluid;
providing a UV light treatment reservoir;
providing a UV light source;
placing the wellbore treatment fluid in the UV light treatment reservoir; and
irradiating the wellbore treatment fluid with the UV light source so as to reduce the first microorganism count of the wellbore treatment fluid to a second microorganism count to form an irradiated wellbore treatment fluid.

2. The method of claim 1, comprising agitating the wellbore treatment fluid.

3. The method of claim 1, comprising aerating the wellbore treatment fluid.

4. The method of claim 1, comprising pumping the irradiated wellbore treatment fluid out of the UV light treatment reservoir and into a subterranean formation, a pipeline, a downstream refining process, a mixing system, or a storage container.

5. The method of claim 1, wherein the UV light source is within the UV light treatment reservoir.

6. The method of claim 1, wherein the UV light source has a wavelength in the range of about 100 to about 500 nm.

7. The method of claim 1, wherein the UV light treatment reservoir comprises a frac tank.

8. The method of claim 1, wherein the first microorganism count is in the range of about 10² to about 10¹⁵ bacteria/mL.

9. The method of claim 1, wherein the second microorganism count is a log₅ reduction of the first microorganism count.

10. The method of claim 1, wherein the wellbore treatment fluid is a turbid wellbore treatment fluid having 1% to 90% transmittance at 254 nm.

11. The method of claim 1, wherein the wellbore treatment fluid comprises a virgin fluid and/or a recycled fluid.

12. The method of claim 1, wherein the wellbore treatment fluid is a flowback treatment fluid or a produced water.

13. The method of claim 1, wherein the wellbore treatment fluid comprises an additive chosen from the group consisting of: a gelling agent, a gel stabilizer, a salt, a pH-adjusting agent, a corrosion inhibitor, a dispersant, a flocculant, an acid, a foaming agent, an antifoaming agent, an H₂S scavenger, a lubricant, a particulate, a bridging agent, a weighting agent, a scale inhibitor, a chemical biocide, a friction reducer, any combination thereof, and any derivative thereof.

14. The method of claim 1, wherein the UV light treatment reservoir comprises a thin film of an inorganic attenuating agent.

15. The method of claim 1, comprising:
adding an attenuating agent to the wellbore treatment fluid, such that a plurality of free radicals are generated by the attenuating agent; and
allowing the free radicals to interact with the microorganisms in the fluid so as to reduce the microorganism count.

16. The method of claim 15, wherein the attenuating agent is an organic attenuating agent chosen from the group consisting of: acetophenone, propiophenone, benzophenone, xanthone, thioxanthone, fluorenone, benzaldehyde, anthraquinone, carbazole, a thioindigoid dye, a phosphine oxide, a ketone, benzoinethers, benzilketals, an alpha-dialkoxyacetophenone, an alpha-hydroxyalkylphenone, an alpha-aminoalkylphenone, an acylphosphineoxide, a benzophenone, a benzoamine, a thioxanthone, a thioamine, any combination thereof, and any derivative thereof.

17. The method of claim 15, wherein the attenuating agent is an inorganic attenuating agent chosen from the group consisting of: a nanosized titanium dioxide, a nanosized iron oxide, a nanosized cobalt oxide, a nanosized chromium oxide, a nanosized magnesium oxide, a nanosized aluminum oxide, a nanosized copper oxide, a nanosized zinc oxide, a nanosized manganese oxide, any combination thereof, and any derivative thereof.

18. The method of claim 15, wherein the UV light source comprises at least one UV bulb inside the UV light treatment reservoir, and at least a portion of the attenuating agent is an inorganic attenuating agent that is placed on a least a portion of the UV bulb.

19. The method of claim 15, wherein the concentration of the attenuating agent in the wellbore treatment fluid is up to about 5% by weight of the wellbore treatment fluid.

20. The method of claim 15, wherein the attenuating agent comprises an organic and/or an inorganic attenuating agent.
